(19) United States
(12) Patent Application Publication
(10) Pub. No.: US 2018/0050491 A1
(43) Pub. Date: Feb. 22, 2018

(54) THREE-DIMENSIONAL SHAPING METHOD AND ADDITIVE MANUFACTURING MATERIAL

(71) Applicant: Kabushiki Kaisha Toshiba, Minato-ku (JP)

(72) Inventors: Haruhiko ISHIHARA, Yokohama (JP); Hideaki HIRABAYASHI, Yokohama (JP)

(73) Assignee: Kabushiki Kaisha Toshiba, Minato-ku (JP)

(21) Appl. No.: 15/556,500

(22) PCT Filed: Sep. 14, 2015
(86) PCT No.: PCT/JP2015/076046

§ 371 Date: Sep. 7, 2017

(30) Foreign Application Priority Data
Mar. 18, 2015 (JP) 2015-055081

(51) Int. Cl. B29C 64/165; B28B 1/32; B22F 3/02; B33Y 70/00; B29C 67/04; B33Y 10/00

(52) U.S. Cl. CPC B29C 64/165; B28B 1/32; B22F 3/02; B29C 67/246; B29C 67/04; B33Y 10/00; B33Y 70/00

(57) ABSTRACT

A three-dimensional shaping method manufactures a three-dimensional shaped object and includes repeatedly performing a process of applying, to material particles each coated with a binder, a reaction solution that dissolves therein the binder or causes a binding reaction with the binder and a process of depositing the material particles. The binders bind with each other by electrostatic force.

### FIELD

Embodiments of the present invention relate to a three-dimensional shaping method and an additive manufacturing material.

### BACKGROUND

There are proposed various three-dimensional shaping methods for manufacturing a three-dimensional shaped object by repeating: a powder layer formation process of forming a powder layer on a manufacturing stage; and a binding process of discharging a binder from an inkjet head to a predetermined area on the deposited powder layer to form a cured layer, for example.

### CITATION LIST

### Patent Literature

Patent Literature 1: Japanese Patent Application Laid-open No. 2010-208069

### SUMMARY OF THE INVENTION

### Problem to be Solved by the Invention

To bind powder, it is necessary to use a solution including a certain amount or more of binding components (solid contents). However, to eject a binder from an inkjet head, liquid properties, such as viscosity, have restrictions. In other words, to increase the manufacturing accuracy, it is necessary to reduce the viscosity of the binder material, which makes it difficult to uniformly bind a powder layer.

The present invention has been made in view of the disadvantages described above and has an object to provide a three-dimensional shaping method and a material for additive manufacturing that are capable of increasing the density and the strength of a three-dimensional shaped object and providing a homogenous three-dimensional shaped object.

### Means for Solving Problem

A three-dimensional shaping method according to an embodiment manufactures a three-dimensional shaped object and includes repeatedly performing a process of applying, to material particles each coated with a binder, a reaction solution that dissolves therein the binder or causes a binding reaction with the binder and a process of depositing the material particles.

### BRIEF DESCRIPTION OF DRAWINGS

FIG. 1 is a schematic diagram for explaining the configuration and processes of a three-dimensional manufacturing system according to an embodiment.

FIG. 2 is a sectional view schematically illustrating a three-dimensional printer according to the embodiment.

FIG. 3 is a perspective view of a main part of a manufacturing tank and a supply device.

FIG. 4 is a diagram (part 1) for explaining combinations of a binder BD used for surface coating on secondary particles and a reaction solution RL.

FIG. 5 is a diagram (part 2) for explaining combinations of the binder BD used for surface coating on the secondary particles and the reaction solution RL.

FIG. 6 is a diagram for explaining a bond between functional groups.

### DETAILED DESCRIPTION

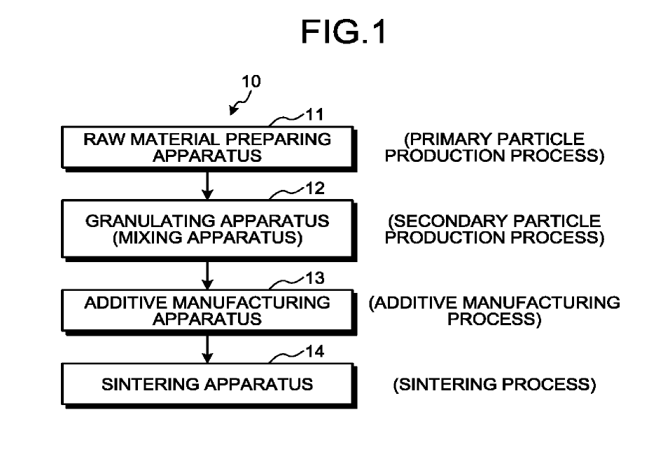

Embodiments are described below with reference to the accompanying drawings. FIG. 1 is a schematic diagram for explaining the configuration and processes of a three-dimensional shaping system according to an embodiment. A three-dimensional shaping system 10 according to the embodiment includes a raw material preparing apparatus 11 that prepares primary particles; a granulating apparatus 12 that mixes the primary particles prepared by the raw material preparing apparatus 11 with a binder BD to produce secondary particles each having a surface coated with the binder; an additive manufacturing apparatus 13 that is a so-called “three-dimensional printer” and deposits the secondary particles to manufacture a three-dimensional shaped object; and a sintering apparatus 14 that heats and sinters the three-dimensional shaped object manufactured by the additive manufacturing apparatus 13 in accordance with a predetermined temperature raising/lowering pattern to provide a sintered object.

Used as the raw material preparing apparatus 11 is an apparatus that appropriately adds an auxiliary agent, including the binder BD, to a powdered ceramic raw material (main material) produced be a solid phase method, a liquid phase method, or a gas phase method and performs crushing, dispersion, mixing, and other processing. For example, used as the raw material preparing apparatus 11 is a crushing and mixing apparatus, such as a ball mill, a bead mill, and a jet mill, for example. A spray drier and the like is further used as needed.

Next, the granulating apparatus 12 is described. The granulating apparatus 12 performs granulation of receiving injection of the primary particles prepared by the first raw material preparing apparatus 11-1 and the second raw material preparing apparatus 11-2 at a predetermined ratio and injection of a predetermined binder as an auxiliary agent, to produce the secondary particles. Used as the granulating apparatus is a crushing and mixing apparatus, such as a ball mill, a bead mill, and a jet mill, for example.

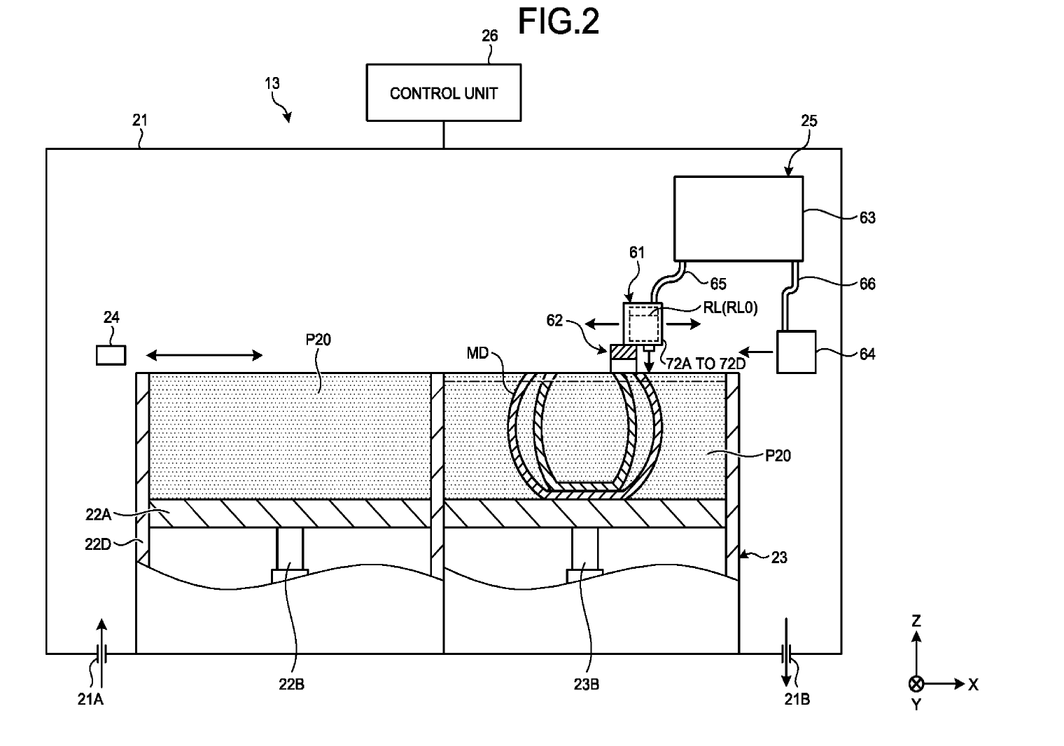

The following describes a three-dimensional printer serving as the additive manufacturing apparatus 13. FIG. 2 is a sectional view schematically illustrating the three-dimensional printer according to the embodiment. A three-dimensional printer 13 is a three-dimensional shaping apparatus employing a powder fixing depositing method. As illustrated in FIG. 2, the three-dimensional printer 13 includes a processing chamber 21; a material tank 22 that accommodates raw materials (secondary particles) for producing a three-dimensional shaped object; a manufacturing tank 23 that actually performs three-dimensional shaping; a wiper device 24 that supplies the raw materials accommodated in the material tank 22 to the manufacturing tank 23; an inkjet shaping device 25 that ejects a reaction solution RL to the raw materials (secondary particles) in units of layers supplied by the wiper device 24 to the manufacturing tank 23 at a position (in a pattern) corresponding to the three-dimensional shaped object on each layer corresponding to slice data; and a control unit 26 that controls the material tank 22, the manufacturing tank 23, the wiper device 24, and the inkjet shaping device 25.

In the configuration described above, the processing chamber 21 has a sealed space inside thereof. The material tank 22, the manufacturing tank 23, the wiper device 24, and the inkjet shaping device 25 are arranged at predetermined positions in the processing chamber 21. The inside of the processing chamber 21 is supplied with an inert gas, such as nitrogen and argon, from a gas supply device, which is not illustrated, through a supply port 21A to keep the inside of the processing chamber clean. Unnecessary gas components or the like generated in three-dimensional shaping are exhausted to the outside of the processing chamber 21 through an exhaust port 21B.

The material tank 22 has a placing table 22A inside thereof in a manner capable of vertically moving by a hydraulic lifting device 22B. Secondary particles P20 serving as the raw materials are placed on the placing table 22A. In three-dimensional shaping, the placing table moves upward at each predetermined shaping step, thereby moving the raw materials of an amount corresponding to a predetermined layer thickness toward an upper part of the material tank 22.

The manufacturing tank 23 includes a placing table 23A, a hydraulic lifting device 23B, and a peripheral wall 23D. The secondary particles P20 serving as the materials are sequentially supplied to the upper face of the placing table 23A based on slice data.

The wiper device 24 includes a squeezing blade. The wiper device 24 is horizontally driven in FIG. 2, thereby supplying, to the manufacturing tank 23, the raw materials of the amount corresponding to the predetermined layer thickness moved toward the upper part of the material tank 22 while leveling them such that they have a uniform thickness.

The inkjet shaping device 25 ejects the reaction solution RL that dissolves a binding layer on the surface of the secondary particles P20 supplied to the manufacturing tank 23 or causes a bonding reaction or the like, thereby causing the secondary particles P20 to bind with each other. The inkjet shaping device 25 thus deposits and fixes the secondary particles P20. The inkjet shaping device 25 includes an ejecting device 61 that ejects the reaction solution RL to the secondary particles P20 supplied to the manufacturing tank 23; a moving device 62 that moves the ejecting device 61; an accommodating device 63 that accommodates the raw materials, and a collecting device 64 that collects the raw materials (secondary particles) that are not used for shaping.

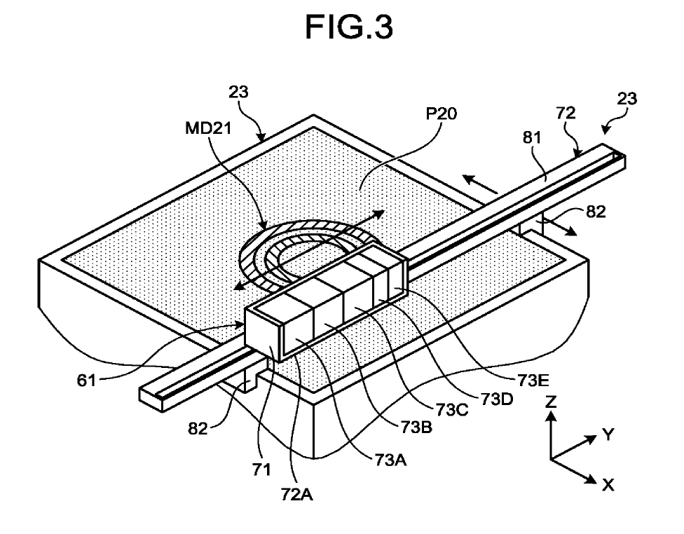

FIG. 3 is a perspective view of a main part of the manufacturing tank and the supply device. As illustrated in FIG. 3, the ejecting device 61 of the inkjet shaping device 25 includes a holder 71; a plurality of nozzles 72A to 72E that are provided integrally with the holder 71; and a plurality of tanks 73A to 73E respectively corresponding to the nozzles 72A to 72E.

The holder 71 holds the tanks 73A to 73E and is provided with the nozzles 72A to 72E on the lower face in a manner corresponding to the tanks 73A to 73E, respectively.

In the configuration described above, the tanks 73A to 73E may store therein the same reaction solution RL or store therein a plurality of different types of undiluted reaction solutions RL0 mixed to function as the reaction solution RL, for example.

To simplify the explanation below, the following describes a case where the tanks 73A to 73E store therein the same reaction solution RL, for example.

The moving device 72 includes a rail 81 and a pair of conveyers 82. The moving device 72 moves the ejecting device 61 in directions along an X-axis and a Y-axis, thereby moving the tanks 73A to 73E integrated with the holder 71 of the ejecting device 61 with respect to the manufacturing tank 23.

The rail 81 is arranged above the manufacturing tank 23 and is longer than the size of the manufacturing tank in the direction along the Y-axis. The holder 71 of the ejecting device 61 can be moved along the rail 81. By driving a mechanism including various parts, such as a motor, a gear, and a belt, the ejecting device 61 is moved along the rail 81. The nozzles 72A to 72E of the ejecting device 61 are also moved along the rail 81 and eject the reaction solution RL, thereby depositing the secondary particles P20 in the manufacturing tank 23.

The collecting device 64 is connected to the accommodating device 63 by a collection tube 66. The collecting device 64 sucks up the powdery secondary particles P20 that are not fixed and transmits and collects them in the accommodating device 63.

In the configuration described above, the control unit 26 controls the manufacturing tank 23, the wiper device 24, and the inkjet shaping device 25 to cause the secondary particles each coated with the fixing agent to fix to each other, thereby additively manufacturing a three-dimensional shaped object MD. Furthermore, the control unit 26 controls the collecting device 64 so as to suck up the powdery secondary particles P20 that are not used for the manufacturing and transmit and collect them in the accommodating device 63.

The three-dimensional shaped object MD manufactured as described above is subjected to heating by the sintering apparatus 14 in accordance with a predetermined temperature raising pattern and a predetermined temperature lowering pattern. The three-dimensional shaped object MD is thus sintered and formed into a three-dimensional shaped object MD2 serving as a sintered object. More specifically, the three-dimensional shaped object serving as a sintered object has a length reduced to substantially 70%. The size of the three-dimensional shaped object is substantially 50% to 60% the size of the three-dimensional shaped object MD by volume.

The following describes preferable combinations of surface coating on the secondary particles with the binder BD and the reaction solution RL in detail. The outline is described first. The following five combinations are given as examples of the combination of the binder BD used for surface coating on the secondary particles and the reaction solution RL.

(1) Binder BD: Organic coating material (e.g., acrylic)

Reaction solution RL: solvent

(2) Binder BD: inorganic coating material (e.g., SiO₂, Al₂O₃, and TiO₂)

Reaction solution RL: solution of inorganic nanoparticles (e.g., the same material as the binder BD or colloidal silica)

(3) Binder BD: inorganic coating material (e.g., SiO₂, Al₂O₃, and TiO₂)

Reaction Solution RL: organic silane solution or the like

(4) Binder BD: metallic coating material

Reaction solution RL: silane coupling agent (e.g., a thiol group)

(5) Binder BD: silane coupling agent (e.g., an amino group)

Reaction solution RL: silane coupling agent (e.g., a carboxyl group)

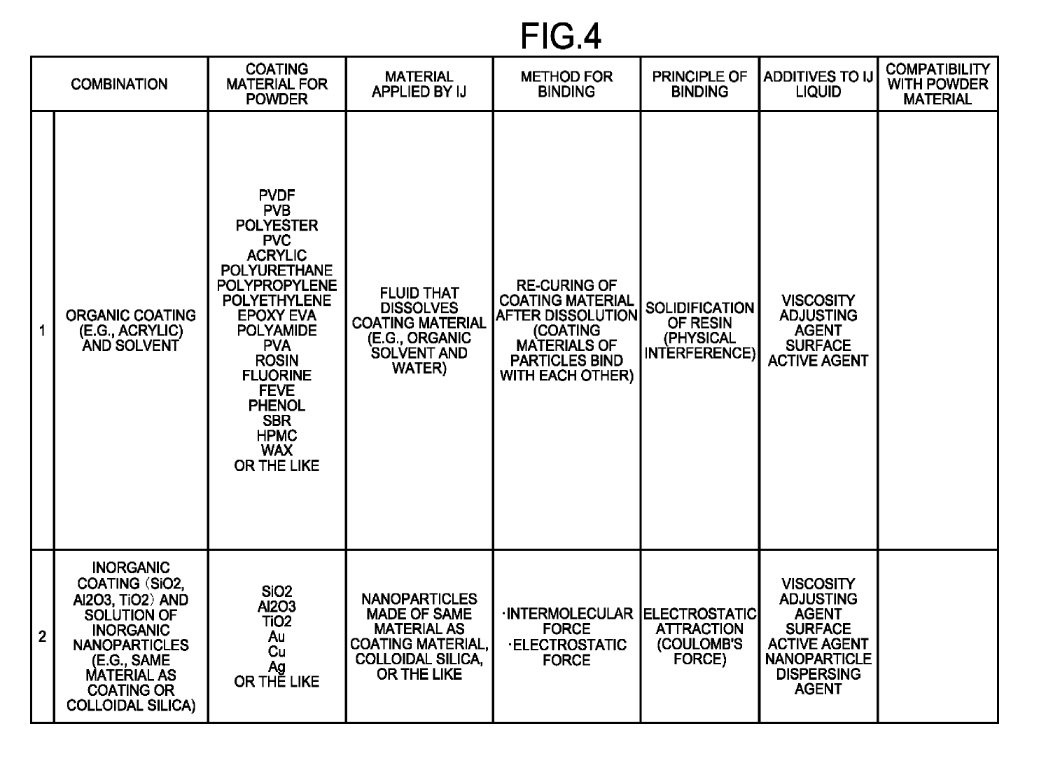

The following describes the combinations of the binder BD and the reaction solution RL in greater detail. FIG. 4 is a diagram (part 1) for explaining the combinations of the binder BD used for surface coating on the secondary particles and the reaction solution RL.

### [1] Organic Coating Material+Solvent

The following describes a case where an organic coating material is used as the binder BD and a solvent is used as the reaction solution RL. As described in the first section in FIG. 4, examples of the binder BD made of an organic coating material include, but are not limited to, PVDF (polyvinylidene difluoride), PVB (polyvinyl butyral), polyester, PVC (polyvinyl chloride), acrylic, polyurethane, polypropylene, polyethylene, epoxy, EVA (ethyl vinyl acetate), polyamide, PVA (polyvinyl alcohol), rosin, fluorine, FEVE (fluoro ethylene vinyl ether), phenol, SBR (styrene-butadiene rubber), HPMC (hydroxypropyl methylcellulose, wax, etc. The organic coating material is appropriately selected from the group described above. As the reaction solution RL, a fluid (e.g., an organic solvent and water) that dissolves the organic coating material is used. In this case, the method for causing the secondary particles P20 to bind with each other is a mechanism in that the secondary particles P20 bind with each other by re-curing of the coating material after dissolution. The binding principle is assumed to be physical interference caused by solidification of a resin. Examples of additives to the reaction solution RL (referred to as an IJ liquid in FIG. 4) applied by the inkjet shaping device 25 include, but are not limited to, a viscosity adjusting agent that provides optimum viscosity, a surface active agent that improves the wettability, etc.

### [2] Inorganic Coating Material+Inorganic Nanoparticle Solution

The following describes a case where an inorganic coating material is used as the binder BD and a solution of inorganic nanoparticles is used as the reaction solution RL.

As described in the second section in FIG. 4, examples of the binder BD made of an inorganic coating material include, but are not limited to, SiO₂ (silicon dioxide), Al₂O₃ (aluminum trioxide), TiO₂ (titanium dioxide), Au (gold,), Cu (copper), Ag (silver), etc. The inorganic coating material is appropriately selected from the group described above.

A solution of nanoparticles made of the same material as the material of the inorganic coating material or a solution of colloidal silica is used as the reaction solution RL. In this case, the method for causing the secondary particles P20 to bind with each other is a mechanism in that the secondary particles P20 bind with each other by intermolecular force and electrostatic force. The binding principle is assumed to be electrostatic attraction (Coulomb's force).

Examples of additives to the reaction solution RL (referred to as the IJ liquid in FIG. 4) applied by the inkjet shaping device 25 include, but are not limited to, a viscosity adjusting agent that provides optimum viscosity, a surface active agent that improves the wettability, a dispersing agent that uniformly disperses the nanoparticles in the solution, etc.

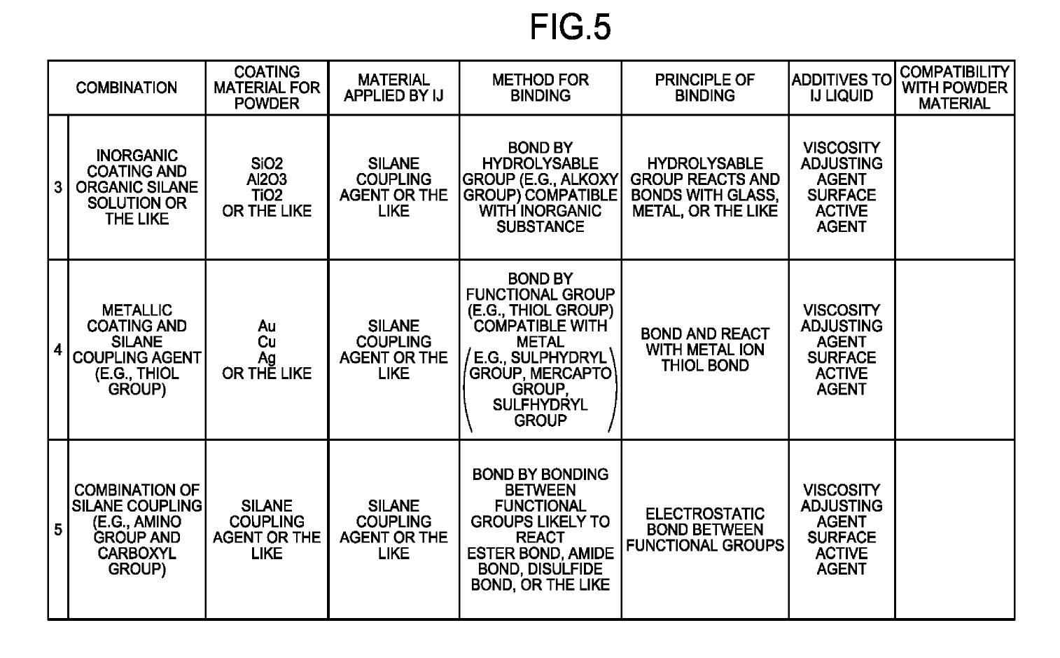

FIG. 5 is a diagram (part 2) for explaining the combinations of the binder BD used for surface coating on the secondary particles and the reaction solution RL.

### [3] Inorganic Coating Material+Organic Silane Solution

The following describes a case where an inorganic coating material is used as the binder BD and an organic silane solution is used as the reaction solution RL.

As described in the third section in FIG. 5, examples of the binder BD made of an inorganic coating material include, but are not limited to, SiO₂ (silicon dioxide), Al₂O₃ (aluminum trioxide), TiO₂ (titanium dioxide), etc. The inorganic coating material is appropriately selected from the group described above. A silane coupling agent is used as the reaction solution RL.

In this case, the method for causing the secondary particles P20 to bind with each other is a mechanism in that the secondary particles P20 bind with each other by bonding force of a hydrolysable group (e.g., an alkoxy group) compatible with (having an affinity for) an inorganic substance. The binding principle is assumed to be that the hydrolysable group reacts and bonds with glass, a metal, or the like.

Examples of additives to the reaction solution RL (referred to as the IJ liquid in FIG. 5) applied by the inkjet shaping device 25 include, but are not limited to, a viscosity adjusting agent that provides optimum viscosity, a surface active agent that improves the wettability, etc.

### [4] Metallic Coating Material+Silane Coupling Agent

The following describes a case where a metallic coating material is used as the binder BD and a silane coupling agent is used as the reaction solution RL. As described in the fourth section in FIG. 5, examples of the binder BD made of a metallic coating material include, but are not limited to, Au (gold), Cu (copper), Ag (silver), etc. The metallic coating material is appropriately selected from the group described above.

A silane coupling agent is used as the reaction solution RL. In this case, the method for causing the secondary particles P20 to bind with each other is a mechanism in that the secondary particles P20 bind with each other by intermolecular force and electrostatic force.

The binding principle is a mechanism in that the secondary particles P20 bind with each other by bonding force of a functional group (e.g., a thiol group [=a sulphydryl group, a mercapto group, or a sulfhydryl group]) compatible with (having an affinity for) a metal.

Examples of additives to the reaction solution RL (referred to as the IJ liquid in FIG. 4) applied by the inkjet shaping device 25 include, but are not limited to, a viscosity adjusting agent that provides optimum viscosity, a surface active agent that improves the wettability, etc.

### [5] Silane Coupling Agent+Silane Coupling Agent

The following describes a case where a silane coupling agent is used as both of the binder BD and the reaction solution RL. As described in the fifth section in FIG. 5, a silane coupling agent is used as the binder BD, and a silane coupling agent is used as the reaction solution RL.

In this case, the method for causing the secondary particles P20 to bind with each other is a mechanism in that the secondary particles P20 bind with each other by bonding force of a bond (e.g., a peptide bond, an ester bond, an amide bond, and a disulfide bond) between functional groups (e.g., amino group+carboxyl group) likely to react (having high reactivity).

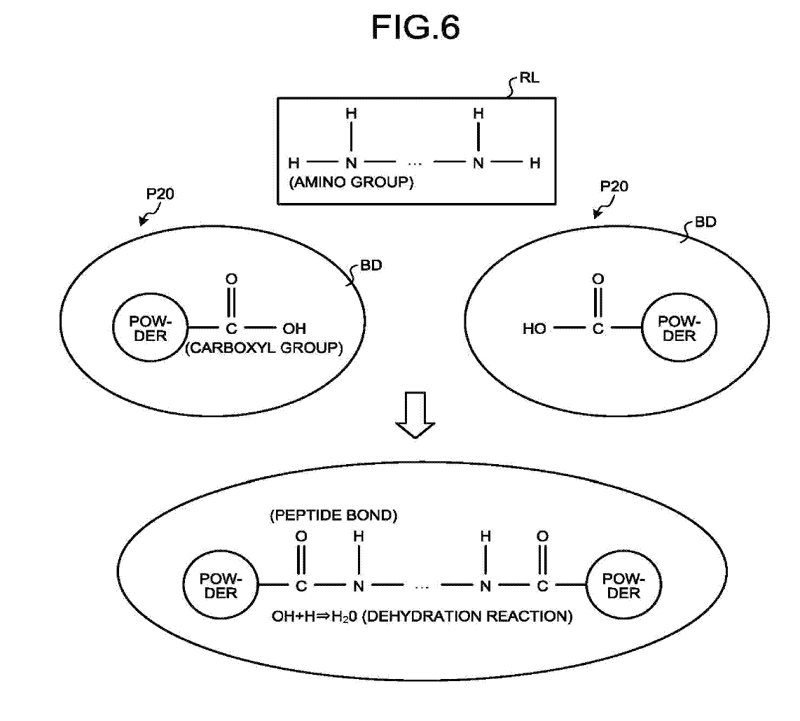

FIG. 6 is a diagram for explaining a bond between functional groups. As illustrated in FIG. 6, if a silane coupling agent having a carboxyl group (—COOH) is used as the binder BD and a silane coupling agent having an amino group (—NH₂) is used the reaction solution RL, a peptide bond is generated by a dehydration reaction (OH+H→H₂O), thereby providing a strong bond.

The binding principle is a mechanism in that the secondary particles P20 bind with each other by electrostatic bonding force between the functional groups. Examples of additives to the reaction solution RL (referred to as the IJ liquid in FIG. 4) applied by the inkjet shaping device 25 include, but are not limited to, a viscosity adjusting agent that provides optimum viscosity, a surface active agent that improves the wettability, etc.

As described above, the reaction solution RL that makes the binder BD for causing the secondary particles P20 to bind with each other into a bindable state according to the present embodiment include no solid contents. This structure facilitates adjustment of the liquid viscosity. As a result, the inkjet shaping device 25 can reliably and uniformly apply the reaction solution RL to the coating layer of the secondary particles P20, thereby uniformly binding a powder layer serving as an aggregate of the secondary particles P20. Consequently, the present embodiment can reduce manufacturing failure and provide a uniform three-dimensional shaped object having high strength and accuracy.

While certain embodiments of the present invention have been described, these embodiments are given by way of example only and are not intended to limit the scope of the invention. The novel embodiments may be embodied in a variety of other forms, and various omissions, substitutions, and changes may be made without departing from the spirit of the invention. The embodiments and the modifications thereof are included in the scope and the spirit of the invention and in the invention described in the claims and their equivalents.

While the embodiments above perform three-dimensional manufacturing using one type of secondary particles, they may perform three-dimensional manufacturing similarly, using a plurality of types of secondary particles, for example.

1: A three-dimensional shaping method for manufacturing a three-dimensional shaped object,
the method comprising:
repeatedly performing
a process of applying, to material particles each coated with a binder, a reaction solution that dissolves therein the binder or causes a biding reaction with the binder, and
a process of depositing the material particles,
wherein
the binders bind with each other by electrostatic force.

2: The three-dimensional shaping method according to claim 1, further comprising a process of adding the binder to primary particles serving as a material for the three-dimensional shaped object to provide the material particles serving as secondary particles each having a surface coated with the binder.

3-4. (canceled)

5: The three-dimensional shaping method according to claim 1, wherein
an inorganic coating material is used as the binder and, the inorganic coating material being selected from a group consisting of SiO₂ (silicon dioxide ), Al₂O₃ (aluminum trioxide), TiO₂ (titanium dioxide), Au (gold), Cu (copper), and Ag (silver), and
an inorganic nanoparticle solution is used as the reaction solution, the reaction solution being selected from a group consisting of a solution of nanoparticles made of the same material as a material of the inorganic coating material and a solution of colloidal silica.

6-10. (canceled)

11: The three-dimensional shaping method according to claim 1, wherein
a first silane coupling agent having a first functional group is used as the binder, and
a second silane coupling agent having a second functional group capable of forming a peptide bond, an ester bond, an amide bond, or a disulfide bond with the first functional group is used as the reaction solution.

12-18. (canceled)

19: A three-dimensional shaping method for manufacturing a three-dimensional shaped object,
the method comprising:
repeatedly performing
a process of adding a binder to primary particles serving as a material for the three-dimensional shaped object, the binder being selected from a group consisting of PVDF (polyvinylidene difluoride), PVB (polyvinyl butyral), polyester, PVC (polyvinyl chloride), acrylic, polyurethane, polypropylene, polyethylene, epoxy, EVA (ethyl vinyl acetate), polyamide, PVA (polyvinyl alcohol), rosin, fluorine, FEVE (fluoro ethylene vinyl ether), phenol, SBR (styrene-butadiene rubber), HPMC (hydroxypropyl methylcellulose), and wax to provide the material particles serving as secondary particles each having a surface coated with the binder, and
a process of applying, to the secondary particles each coated with the binder, a reaction solution that dissolves therein the binder or causes a biding reaction with the binder, and
a process of depositing the secondary particles.
